(19) United States
(12) Patent Application Publication
(10) Pub. No.: US 2008/0133588 A1
(43) Pub. Date: Jun. 5, 2008

(54) Structure Of A Management Information Base Communicated Between A Network Management System And An Agent Of A Network Element

(75) Inventor: Kwang Seok Kang, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited, Kyongki-do (KR)

(21) Appl. No.: 10/585,838

(22) PCT Filed: Jan. 14, 2005
(86) PCT No.: PCT/KR05/00141

§ 371 Date: Apr. 30, 2007

(30) Foreign Application Priority Data
Jan. 15, 2004 (KR) 10-2004-0002983

(51) Int. Cl. H04Q 7/34

(52) U.S. Cl. 707/103 X

(57) ABSTRACT

The present invention relates to a structure of a Management Information Base (MIB) communicated between a Network Management System (NMS) and an agent of a Network Element (NE). Conventionally, an operator provides the MIB to the NMS and the NE agent before the communication. If the MIB is not provided before the communication, the NMS cannot know what data to be retrieved from the NE agent and thus cannot understand the MIB. In order to resolve this problem, the present invention suggests using the claimed structure of MIB for communicating between the NMS and the NE agent. According to the present invention, when a MIB of the NE agent is changed, the MIB of the NE agent is reflected to the NMS automatically, and not by an operator's action. Therefore, the network can be managed automatically.

### TECHNICAL FIELD

The present invention generally relates to a meta structure of a Management Information Base (MIB) of a Network Element (NE) agent for automatically constructing MIB information in a Network Management System (NMS), and more particularly to a meta structure of a MIB that allows a NMS to receive MIB information online from an agent to perform quick and correct network management in Simple Network Management Protocol (SNMP) network management architecture.

### BACKGROUND ART

Generally, a SNMP is a protocol for managing a network and monitoring and supervising network devices. Further, a SNMP allows a remote user to logically examine and change management information for network elements. A Structure of Management Information (SMI) (which describes the structure of management information of the SNMP), a MIB (which is definitive for management information) and a SNMP (which is a communication protocol) are standard components for managing a network based on a TCP/IP. These provide structures and functions operable for an Internet network management.

A SNMP network management structure model is executed by exchanging management information between a NMS application of a network management equipment and an agent of an NE.

In order to process management information items between a NMS and a NE agent, a NMS and a NE agent offline share a MIB definition document of SMI standard describing management items. However, when the MIB is not shared between a NMS and a NE agent, a problem may occur in that the NMS does not properly manage the NE.

Network management is focused such that a NMS receives a MIB of a NE from a NE agent online to perform speedy and correct network management.

A SNMP is a standardized protocol for managing a network in the Internet and its latest version is version-3. A conventional structure of network management using a SNMP comprises one NMS and one or more NE agents.

The NE agents are incorporated in various network elements managed in a network, directly accesses information generated by network elements and transmit to a NMS the information in a format matching with a SNMP. A SNMP, a SMI and a MIB, which are standard components for managing an Internet network, is basically defined by Abstract Syntax Notation.1 (ASN.1). Encoding and decoding them are performed according to a Basic Encoding Rule (BER), which is an ASN.1 manner.

Also, the SNMP supports operations such as Get-Request, GetNext-Request, Set-Request, Response, Trap and so on, in which management information is exchanged between a manager and an agent.

In a conventional network management using a SNMP, a MIB means management information is communicated between a NE agent and a NMS by using a SNMP. Accordingly, the MIB is beforehand shared between a NMS and a NE agent. Since the MIB is defined according to a SMI format, the MIB defined by SMI can be considered as a set of management objects, where each management object has a unique identifier and properties.

The identifier of each management object has a unique value and its properties are configured on the basis of the format defined in SMI. As shown in FIG. 1, a general structure using a SNMP has a MIB sharing structure, where the MIB must be provided to a NMS and a NE agent, while an operator generally performs theses tasks.

However, a MIB must be shared beforehand to update a MIB in a conventional network management using a SNMP. Otherwise, the NMS does not know which kind of object information to retrieve. Even though the NMS may retrieve the specific information, it cannot understand the meanings thereof.

### DISCLOSURE OF THE INVENTION

Thus, the present invention is provided in order to solve the above-described problems associated with the prior art. The objective of the present invention is to provide a meta structure of a MIB of a NE agent for automatically constructing MIB information in a NMS so that the correct MIB information of an agent can be automatically maintained without a user judging whether the MIB information has changed in case that the agent's MIB information has changed.

Therefore, in order to achieve the above objective, a structure of a MIB, which is communicated between a NMS and an agent of an NE according to the present invention, comprises a baseInfo for creating an objectInfoTable for describing object-type objects, a trapInfoTable for describing trap-type objects, a baseInfoTable for describing common properties of MIB objects, and a syntaxInfo for creating a syntaxIntegerTable and a sequenceInfoTable.

### BRIEF DESCRIPTION OF DRAWINGS

Understanding that these drawings depict only typical embodiments of the invention and are, therefore, not to be considered limiting of its scope, the invention will be described with additional specificity and detail through use of the accompanying drawings in which:

FIG. 1 illustrates a block diagram showing the configuration of a conventional HANS-5 switch router.

FIG. 2 illustrates the configuration of a NE agent for automatically constructing MIB information in a NMS in accordance with an embodiment of the present invention.

FIG. 3 illustrates a meta MIB structure of a NE agent for automatically constructing MIB information in a NMS in accordance with an embodiment of the present invention.

### BEST MODE FOR CARRYING OUT THE INVENTION

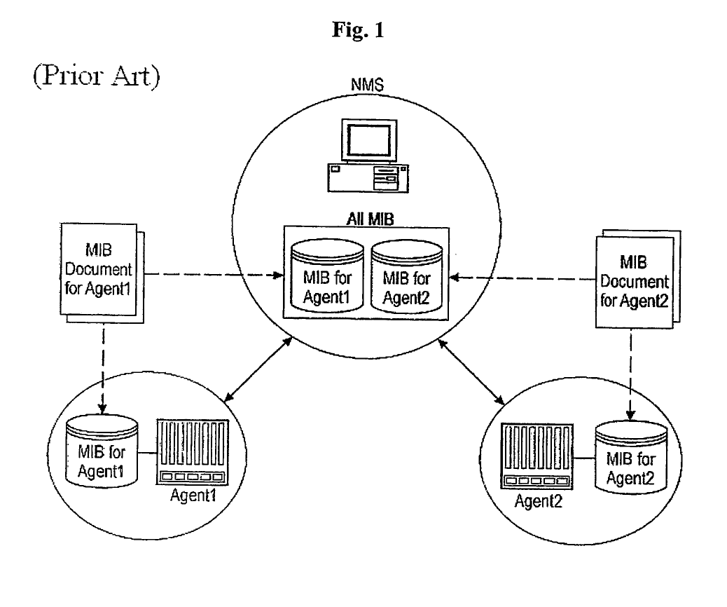

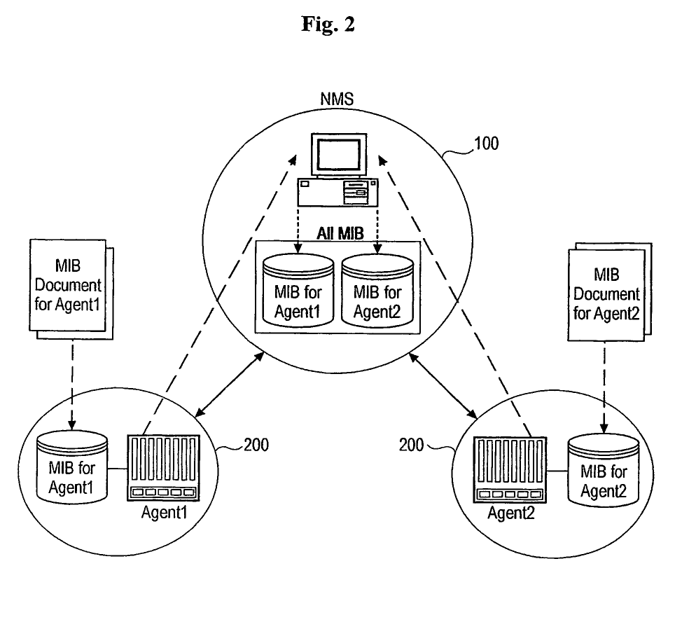

It will be readily understood that the components and steps of the present invention, as generally described and illustrated in the Figures herein and accompanying text, could be arranged and designed in a wide variety of different configurations while still utilizing the inventive concept. Thus, the following detailed description of the preferred embodiments of the structure of the present invention, as represented in FIGS. 1 through 3 and accompanying text, is not intended to limit the scope of the invention, as claimed. It is merely representative of the presently preferred embodiments of the invention. The presently preferred embodiments of the invention will be best understood by reference to the drawings.

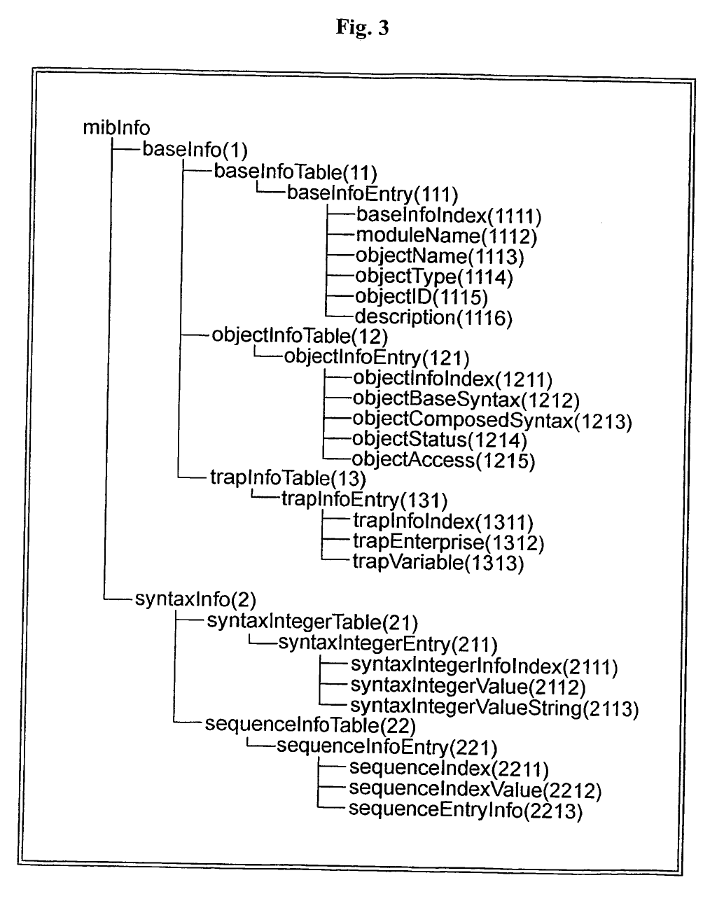

FIG. 3 illustrates a meta MIB structure of a NE agent for automatically constructing MIB information in a NMS in accordance with an embodiment of the present invention. A meta MIB structure in accordance with one embodiment of the present invention comprises baseInfo 1 and syntaxInfo 2.

First, referring to the meta MIB structure, baseInfo 1 functions to create objectInfoTable 12 (which describes object-type objects) and trapInfoTable 13 (which describes trap-type objects) concurrently with creating baseInfoTable 11 reflecting common properties of MIB objects.

BaseInfoTable 11 comprises: baseInfoEntry 111, which includes baseInfohIndex 1111 distinguishing instances of tables; moduleName 1112; objectName 1113 mapped to names of all the management objects in a MIB for agent 200; objectType 1114 describing types of management objects in a MIB for agent 200 mapped to a notification type; objectID mapped to OIDs of management objects in a MIB for agent 200; and description 1116 mapped to MIB management objects in a MIB.

ObjectInfoTable 12 comprises: objectInfoEntry 121, which includes objectInfoIndex 1211 distinguishing instances of tables; objectBaseSyntax 1212 describing syntax of a ASB for agent 200 and having Integer (Integer, Octet, String, Object Identifier) which is an initial type of ASN.1, and Sequence and Sequence Of which are composed types; objectComposedSyntax 1213 using display strings for abstract syntaxes; objectStatus 1214 describing status kinds of MIB objects for agent 200 and mapped to Mandatory, Optional and Obsolete, etc. by using integers as abstract; and objectAccess 1215 describing the kind of access of MIB objects for agent 200 and mapped to Read, Read/Write, Write, Access-Deny by using integers as abstract syntaxes.

TrapInfoTable 13 comprises: trapInfoEntry 131, which includes trapInfoIndex 1311 distinguishing instances; trapEnterprise 1312 mapped to enterprise values of track-type objects in a MIB for agent 200 and mapped to a NULL value if a notification type; and trapVariable 1313 mapped to variable values of trap type objects in a MIB for agent 200 and mapping target values if a notification type.

SyntaxInfo 2 functions to create syntaxIntegerTable 21 and sequenceInfoTable 22.

SyntaxIntegerTable 21 comprises: syntaxIntegerEntry 211, which includes syntaxIntegerInfoIndex 2111 distinguishing instances of tables in a MIB for agent 200; syntaxIntegervalue 2112 mapped to a sub-type of Integer of a MIB for agent 200; and syntaxIntegerValueString 2113 one-to-one mapping strings to expression of a sub-type of syntax Integer of a MIB for agent 200.

SequenceInfoTable 22 comprises: sequenceInfoEntry 221, which includes sequenceIndex 2211 distinguishing instances; sequenceIndexValue 2212 mapped to table indexes of a MIB for agent 200 and whose values are equal to a value indicating table indexes of a MIB for agent 200 among baseInfoIndex 1111; and sequenceEntryInfo 2213 mapped to entry instances of a MIB for agent 200 and whose values are equal to values indicating entry instances of a MIB for agent 200 among baseInfoIndex 1111.

### INDUSTRIAL APPLICABILITY

According to a meta structure of a MIB of a NE agent for automatically constructing MIB information in a NMS in accordance with the present invention, a MIB between a NMS and a NE agent can be shared online rather than offline.

1. A structure of a Management Information Base (MIB) communicated between a Network Management System (NMS) and an agent of a Network Element (NE), the structure comprising:
a baseInfo for creating an objectInfoTable for describing object-type objects, a trapInfoTable for describing trap-type objects, and a baseInfoTable for describing common properties of MIB objects; and
a syntaxInfo for creating a syntaxIntegerTable and a sequenceInfoTable.

2. The structure of claim 1, wherein the baseInfoTable comprises: baseInfoEntry, which includes a baseInfoIndex distinguishing instances of tables; a moduleName; an objectName mapped to names of all the management objects in a MIB for agent; an objectType describing types of management objects in a MIB for agent mapped to a notification type; an objectID mapped to OIDs of management objects in a MID for agent; and a description mapped to MIB management objects in a MIB.

3. The structure of claim 1, wherein the objectInfoTable comprises: objectInfoEntry, which includes an objectInfoIndex distinguishing instances of tables; an objectBaseSyntax describing syntax of a MIB for agent and having Integer (Integer, Octet, String, Object Identifier) which is a initial type of ASN.1, and Sequence and Sequence Of which are composed types; an objectComposedSyntax using display strings for abstract syntaxes; and objectStatus describing status kinds of MIB objects for agent and mapped to Mandatory, Optional and Obsolete, etc. by using integers as abstract; and objectAccess describing the kind of access of MID objects for agent and mapped to Read, Read/Write, Write, Access-Deny by using integers as abstract syntaxes.

4. The structure of claim 1, wherein the trapInfoTable comprises: trapInfoEntry, which includes a trapInfoIndex distinguishing instances; a trapEnterprise mapped to enterprise values of track-type objects in a MID for agent and mapped to a NULL value if a notification type; and a trapVariable mapped to variable values of trap type objects in a MIB for agent and mapping target values if a notification type.

5. The structure of claim 1, wherein the syntaxIntegerTable comprises: a syntaxIntegerEntry, which includes a syntaxIntegerInfoIndex distinguishing instances of tables in a MIB for agent; a syntaxIntegervalue mapped to a sub-type of Integer of a MIB for agent; and a syntaxIntegerValueString one-to-one mapping strings to expression of a sub-type of syntax Integer of a MIB for agent.

6. The structure of claim 1, wherein the sequenceInfoTable comprises: a sequenceInfoEntry, which includes a sequenceIndex distinguishing instances; a sequenceIndexValue mapped to table indexes of a MIB for agent and whose values are equal to a value indicating table indexes of a MIB for agent among the baseInfoIndex; and a sequenceEntryInfo mapped to entry instances of a MIB for agent and whose values are equal to values indicating entry instances of a MIB for agent among the baseInfoIndex.
